(19) United States
(12) Patent Application Publication
(10) Pub. No.: US 2026/0131519 A1
(43) Pub. Date: May 14, 2026

(54) APPARATUS AND METHOD FOR TRANSPORTING PLASTIC PREFORMS

(71) Applicant: KRONES AG, Neutraubling (DE)

(72) Inventors: Dieter WUENSCHE, Straubing (DE); Juergen BEUTL, Sinzing (DE)

(21) Appl. No.: 19/388,471

(22) Filed: Nov. 13, 2025

(30) Foreign Application Priority Data
Nov. 13, 2024 (DE) 102024133247.6

(51) Int. Cl. B29C 49/42

(52) U.S. Cl. CPC B29C 49/42065; B29C 49/42095; B29C 49/42414

(57) ABSTRACT

An apparatus for transporting plastic preforms having main body and a mouth region, has a first roller rotatable with respect to a first axis of rotation and a second roller rotatable with respect to a second axis of rotation, wherein the first axis of rotation and the second axis of rotation run parallel to each other and a gap is formed between the first roller and the second roller, which gap is dimensioned such that the main body can pass through this gap and the mouth region cannot pass through this gap, wherein the plastic preforms are transportable along this gap and with at least one application device which applies a gaseous medium, and in particular air, to the plastic preforms, wherein the application device is arranged in such a way as to apply the gaseous medium to the plastic preforms in their mouth region.

### CROSS REFERENCE TO RELATED APPLICATION

The present invention claims benefit of priority to German Patent Application Serial No. 102024133 247.6, filed November 13, 2024, the contents of which are incorporated herein by reference.

### BACKGROUND OF THE INVENTION

The present invention relates to an apparatus and to a method for transporting plastic preforms which are used for producing containers. Such plastic preforms are commonly used in the prior art in order to be formed into plastic bottles by a forming device such as a stretch blow-molding machine. Typically, such plastic preforms are first aligned or sorted from a disordered state, for example a silo, and then transported. A common method used to carry out this process are so-called roller sorters.

Such roller sorters have two rollers arranged parallel to each other, between which the main bodies of the plastic preforms are transported, in particular while such rollers are rotating, wherein other regions of the plastic preforms, in particular their support rings, cannot pass through the gap formed between the rollers.

Over time, attempts have always been made to increase the throughput of such systems. In the meantime, the aim is to achieve throughputs of 80,000 – 100,000 plastic preforms per hour. From the applicant's internal prior art, a procedure is known in which compressed air is applied to the main bodies of the plastic preforms in order to move them more quickly.

In other words, in a high-performance fitting-out region air from below is blown onto the plastic preforms. Such blowing-on causes the blown-on plastic preforms to align with the main body facing forward in the direction of travel. This in turn can lead to increased disruptions and, for example, jamming of the plastic preforms.

DE 2020 19 104 001 U1 describes a transport apparatus for transporting plastic preforms which has a first rail guidance device and a second rail guidance device, which extend parallel to each other in a predetermined transport direction and at a predetermined distance from each other. Air guidance devices are formed adjacent to the rail guidance devices and in particular above the rail guidance devices.

EP 4 375 046 A1 describes a transport apparatus for transporting preforms, having a conveyor lane extending along a conveying direction, wherein the conveyor lane has a container guide with a guide slot extending in the conveying direction and wherein a first group of fluid channels arranged above the guide slot is provided, the group being fluidically connected to the conveyor lane and the at least one drive channel.

The present invention is therefore based on the object of achieving a transportation and the alignment or sorting described herein even at high throughput rates and in particular with reduced susceptibility to failure.

### SUMMARY OF THE INVENTION

An apparatus according to the invention for transporting containers and in particular plastic preforms, which have a main body and a mouth region, has a first roller rotatable with respect to a first axis of rotation and a second roller rotatable with respect to a second axis of rotation, wherein the first axis of rotation and the second axis of rotation run parallel to each other.

Furthermore, a gap is formed between the first roller and the second roller, wherein the main body of the plastic preform or the main bodies of the plastic preforms can pass through this gap and the mouth section(s) of the plastic preform(s) cannot pass through this gap.

In this way, it is preferably achieved that the plastic preforms are transported suspended, in particular on the support rings and/or mouth regions.

The plastic preforms can be transported along this gap and/or are transported along this gap and at least one application device is provided which applies a gaseous medium and in particular (compressed) air to the plastic preforms.

Preferably, this application of compressed air serves to accelerate or push the plastic preforms in a certain direction, in particular the transport direction.

According to the invention, the application device is configured such as to apply the gaseous medium to the mouth region of the plastic preform(s).

Preferably, the application device is configured in such a way that it does not apply the gaseous medium to at least lower regions of the main bodies of the plastic preforms. A lower region is understood to mean at least a lower third of the main bodies (in a vertical orientation with the mouth facing upwards), preferably a lower half of the main bodies and particularly preferably the lower two thirds of the main bodies and preferably the lower three quarters of the main bodies.

Preferably, the apparatus comprises a first drive device which drives the first roller to rotate relative to its axis of rotation. Preferably, the apparatus comprises a second drive device which drives the second roller to rotate relative to its axis of rotation. Preferably, the rotation of the first roller and the rotation of the second roller are synchronized with each other. This synchronization can be done by a gearbox or by an electronic controller. Preferably, the drive apparatus(es) are electric motors and in particular servomotors.

Preferably, the two rollers are driven in opposite directions of rotation but in particular at the same rotational speed. Preferably, the two rollers have a length in their longitudinal direction, i.e. along their axis of rotation, which is greater than 20 cm, preferably greater than 40 cm and particularly preferably greater than 50 cm, preferably greater than 100 cm, preferably greater than 200 cm, preferably greater than 300 cm and particularly greater than 400 cm and particularly preferably greater than 500 cm.

Preferably, the two rollers have a length in their longitudinal direction, i.e. along their axes of rotation, which is less than 900 cm, preferably less than 800 cm, preferably less than 750 cm and particularly preferably less than 700 cm.

In this way, it is achieved that the main bodies of the plastic preforms are not pushed forward, which reduces the risk of splitting, which is partly the case in the prior art. In a further preferred embodiment, the rotatable rollers are aligned almost horizontally. Particularly preferably, they are slightly inclined so that the plastic preforms are pushed in their transport direction by the downhill force as well.

In a further preferred embodiment, the two rollers have the same roller diameter.

Particularly preferably, such diameter is greater than 2 cm, preferably greater than 4 cm, particularly preferably greater than 6 cm. Such diameter is preferably less than 50 cm, preferably less than 40 cm, preferably less than 30 cm, preferably less than 25 cm, preferably less than 20 cm and particularly preferably less than 15 cm and particularly preferably less than 10 cm and particularly preferably less than 8 cm.

Such dimensions of the rollers have proven to be particularly advantageous in making possible high throughput and high conveying rates.

Particularly preferably, the rollers have a coating on their outer surface, which faces the plastic preforms to be transported, and in particular a coating which promotes sliding of the plastic preforms along the gap.

Particularly preferably, at least two application devices are arranged one after the other in the transport direction of the plastic preforms. Preferably, these two application devices are arranged directly one after the other.

In a further preferred embodiment, the at least one application device is arranged such that the gaseous medium emerging from the application device emerges also at least in the transport direction of the plastic preforms.

Particularly preferably, the gaseous medium pushes the plastic preforms in their transport direction and in this way preferably accelerates this movement of the plastic preforms in the transport direction.

Preferably, therefore, a main flow direction of the air emerging from the application device extends at least also in the transport direction of the plastic preforms.

In a preferred embodiment, the application device has a plurality of outlet openings for the gaseous medium, through which the gaseous medium can be directed onto the plastic preforms.

Preferably, such plurality of outlet openings extends along the transport direction of the plastics preforms.

Preferably, a minimum distance between the individual plastic preforms and in particular their mouth regions and the respective outlet openings is less than 10 cm, preferably less than 8 cm, preferably less than 6 cm, preferably less than 5 cm, preferably less than 4 cm, particularly preferably less than 3 cm and particularly preferably less than 2.5 cm and particularly preferably less than 2.0 cm and particularly preferably less than 1.5 cm.

Preferably, a minimum distance between the individual plastic preforms and in particular their mouth regions and the respective outlet openings is greater than 0.1 cm, preferably greater than 0.2 cm, preferably greater than 0.3 cm, preferably greater than 0.4 cm, particularly preferably greater than 0.5 cm.

Due to these dimensions of the distance a particularly energy-efficient application of the plastic preforms can be achieved.

Preferably, these outlet openings are inclined and particularly preferably inclined in such a way that the gaseous medium exits through them also at least in the transport direction of the plastic preforms.

Particularly preferably, the outlet openings have a polygonal shape. Preferably, the openings have a rectangular cross-section. Preferably, the openings have a length extension that is between 5 mm and 9 mm, preferably between 6 mm and 8 mm. Particularly preferably, the openings have a width extension that is between 1 mm and 5 mm, preferably between 1 mm and 3 mm.

Preferably, an exit angle of the outlet openings is between 10° and 50°, preferably between 15° and 45°, preferably between 20° and 40° and particularly preferably between 20° and 30°.

Particularly preferably, the outlet openings are arranged on both sides of the respective mouths or mouth sections of the plastic preforms. The mouths or mouth sections refer to those sections of the plastic preforms which have the actual mouth region, but also those regions where the (external) threads of the plastic preforms and preferably also the respective support rings are located.

Particularly preferably, it is a plurality of preferably essentially similar openings. Particularly preferably, the number of such outlet openings (in one of the application devices) is greater than 4, preferably greater than 6, preferably greater than 8, preferably greater than 10 and preferably greater than 12 and preferably greater than 16 and particularly preferably greater than 20.

Particularly preferably, the number of such outlet openings is less than 300, preferably less than 250, preferably less than 200, preferably less than 150 and particularly preferably less than 100 and particularly preferably less than 80.

Particularly preferably, the outlet openings are gill-shaped. For example, a plurality of parallel gaps can be provided.

Particularly preferably, a region where the outlet openings are arranged extends in the transport direction of the plastic preforms. This region is particularly preferably longer than 3 cm, preferably longer than 4 cm, preferably longer than 5 cm and preferably longer than 6 cm. The region where the outlet openings are arranged is preferably shorter than 40 cm, preferably shorter than 35 cm, preferably shorter than 30 cm, and particularly preferably shorter than 25 cm.

In a further preferred embodiment, the application device is arranged at least in sections above the first roller and the second roller. In this way, particularly efficient application of the mouth regions of the plastic preforms is possible.

In particular, at least one of the two application devices and preferably both application devices are arranged completely above the two rollers and/or above the transported plastic preforms.

Particularly preferably, at least one application device is arranged in an end section of the rollers relative to the transport direction of the plastic preforms.

Preferably, at least one application device is arranged in a transition region between the rollers and a further transport device for transporting the plastic preforms that is located after the rollers.

Particularly preferably, the application device is also arranged above the gap formed between the rollers.

Particularly preferably, the application device is configured symmetrically with respect to the two rollers or the gap formed between the rollers.

In a further preferred embodiment, the application device has a collection chamber (for the gaseous medium used for application) which serves to collect the gaseous medium, wherein the gaseous medium can preferably reach the above-mentioned individual outlet openings from this collection chamber. This collection chamber can be connected to a compressed air source. Particularly preferably, the outlet openings are formed in a wall delimiting the collection chamber.

Particularly preferably, the pressure of a compressed air supplied (in particular to the collection chamber) lies in a range between 0.1 bar and 2 bar, preferably between 0.1 bar and 1.5 bar, preferably between 0.1 bar and 1.0 bar and preferably between 0.3 bar and 1.0 bar.

It is possible to already use sterile air as compressed air in this region in order to prevent further contamination of the plastic preforms by the application of compressed air.

In a further preferred embodiment, the apparatus comprises a hold-down device arranged above the rollers, which is suitable and intended to prevent the plastic preforms from escaping upwards from the gap.

Particularly preferably, the application device is formed on this hold-down device. For example, the above-mentioned collection chamber can also be part of the hold-down device.

In a further preferred embodiment, the apparatus comprises a guide blade for guiding the transported plastic preforms. Particularly preferably, an application device is arranged on such guide blade.

Preferably, the two application devices described herein are provided, namely one on said guide blade and one on said hold-down device.

Overall, an adaptation, in particular with a gill configuration, is installed in this way on a holder that blows on the plastic preforms in the mouth region. In addition, an air outlet with a gill configuration is preferably installed on the guide blade, which blows on the plastic preforms in the mouth region.

In a further advantageous embodiment, the apparatus comprises an ejection device which is suitable and intended to eject incorrectly oriented plastic preforms. Particularly preferably, the at least one application device is arranged in the transport device of the plastic preforms downstream of this ejection device.

In a preferred embodiment, the ejection device is arranged above the two rollers. Particularly preferably, the ejection device comprises a rotatable wheel which is arranged above the rollers and in particular also above said gap.

Particularly preferably, an axis of rotation of this wheel is aligned perpendicular to an axis of rotation of the rollers.

The present invention is further directed to a method for transporting plastic preforms, wherein the plastic preforms have a main body and a mouth region, and wherein a first roller rotating with respect to a first axis of rotation and a second roller rotating with respect to a second axis of rotation are provided, wherein the first axis of rotation and the second axis of rotation run parallel to each other, and wherein a gap is formed between the first roller and the second roller, which gap is dimensioned such that the main body (of the plastic preforms) passes through this gap and the mouth region of the plastic preforms does not pass through this gap, wherein the plastic preforms are transported along this gap. Furthermore, an application device is provided which applies a gaseous medium, in particular air, to the plastic preforms.

A flow direction of this air preferably runs at least partially and preferably in an or the transport direction of the plastic preforms.

According to the invention, the application device is arranged such that it applies the gaseous medium to the plastic preforms in their mouth region and preferably substantially only in their mouth region.

Preferably, the application device is arranged such as to apply the gaseous medium to an outer wall of the plastic preforms in their mouth region. The gaseous medium can thus be applied in particular to a threaded region of the plastic preforms.

Preferably, air flow velocities are between 5 km/h and 300 km/h, preferably between 5 km/h and 200 km/h and particularly preferably between 20 km/h and 160 km/h.

### BRIEF DESCRIPTION OF THE DRAWINGS

Further advantages and embodiments can be seen in the accompanying drawings.

in which:

FIGS. 1a,b show two partial representations of an apparatus according to the invention;

FIG. 2 shows a detailed representation of the apparatus shown in FIG. 1; and

FIG. 3 shows a further detailed representation of the apparatus shown in FIG. 1.

### DETAILED DESCRIPTION OF THE INVENTION

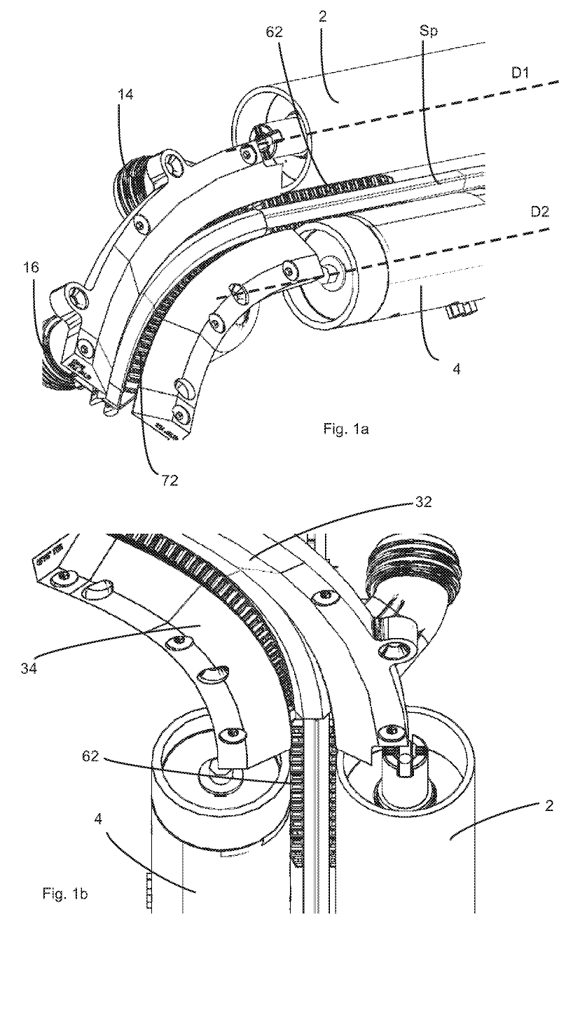

FIGS. 1a,b show two partial representations of an apparatus according to the invention. This apparatus comprises a first roller 2 rotatable with respect to a first axis of rotation D1 and a second roller rotatable with respect to a second axis of rotation D2. A gap is formed between these two rollers 2 and 4, in which gap the main bodies of the plastic preforms (not shown) are transported.

Reference sign 62 denotes first outlet openings, which here are arranged above the two rollers 2, 4 and which serve to convey the plastic preforms.

Reference sign 72 denotes second outlet openings, which here are also arranged above the plastic preforms to be transported, but in particular before the two rollers 2, 4.

Reference signs 32 and 34 denote guide rails which serve to guide the plastic preforms (not shown). Preferably, the upper edges of these guide rails terminate in such a way that the plastic preforms can be transferred to the gap between the two rollers 2 and 4 at the correct height.

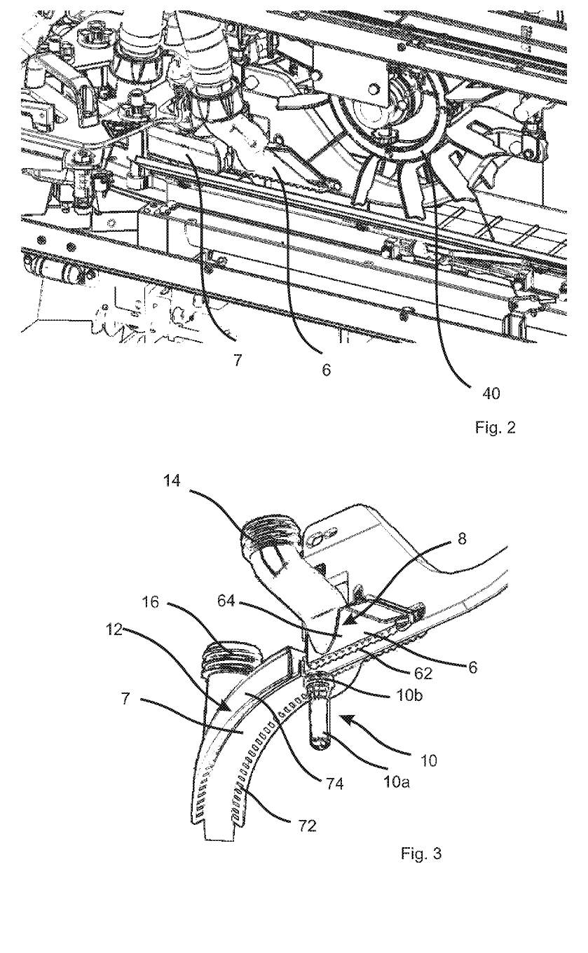

FIG. 2 shows a detailed representation of the apparatus shown in FIG. 1. A first application device 6 and a second application device 7 are provided. They are preferably arranged one after the other in the transport direction of the plastic preforms. Both serve to transport or push the plastic preforms (not shown) in the transport direction T.

FIG. 3 shows a detailed representation of the application devices 6,7. The first application device 6 and second application device 7 can be seen once again. They serve to apply compressed air to a plastic preform 10, which has a main body 10a and a mouth region 10b, so that it is moved more quickly in the transport direction T.

Reference sign 8 denotes a hold-down device on which a plurality of outlet openings 62 are formed, through which the air can emerge in order to be applied to the plastic preforms. The application device 6 forms a collection chamber 64 for receiving the air which serves for application to the plastic preforms. The application device 7 also forms a collection chamber for collecting the air used for application to the plastic preforms.

A plurality of outlet openings 72 are also provided on the device 12 which is a guide blade. These too are gill-shaped and ensure that compressed air is applied to the plastic preforms in the transport direction.

Reference signs 14 and 16 denote connections via which compressed air is to be supplied in the application devices six and seven. Reference sign 40 denotes an optional ejection device which is suitable and intended for ejecting in particular incorrectly oriented or defective plastic preforms.

It is to be noted that all features which have been described with reference to the method are also disclosed in a corresponding manner for the apparatus, which means in particular that the corresponding apparatus has devices which are suitable and intended for carrying out the particular methods. Furthermore, features which were described with reference to the apparatus are also correspondingly applicable to the method or methods. This means that the methods are carried out using the corresponding apparatus features.

The applicant reserves the right to claim all features disclosed in the application documents as essential to the invention, provided that they are novel over the prior art individually or in combination. It is also pointed out that features which can be advantageous in themselves are also described in the individual figures. A person skilled in the art will immediately recognize that a

particular feature described in a figure can be advantageous even without the adoption of further features from this figure. Furthermore, a person skilled in the art will recognize that advantages can also result from a combination of several features shown in individual or in different figures.

1. An apparatus for transporting plastic preforms, which have a main body and a mouth region, having a first roller rotatable with respect to a first axis of rotation and a second roller rotatable with respect to a second axis of rotation, wherein the first axis of rotation and the second axis of rotation run parallel to each other and a gap is formed between the first roller and the second roller, which gap is dimensioned such that the main body can pass through this gap and the mouth region cannot pass through this gap, wherein the plastic preforms are transportable along this gap and with at least one application device which applies a gaseous medium to the plastic preforms,
wherein
the application device is configured to apply the gaseous medium to the plastic preforms in their mouth region.

2. The apparatus according to claim 1,
wherein
the application device is configured such that the gaseous medium emerging from the application device emerges also at least in the transport direction of the plastic preforms.

3. The apparatus according to claim 1,
wherein
the application device has a plurality of outlet openings for the gaseous medium, through which the gaseous medium can be directed onto the plastic preforms.

4. The apparatus according to claim 3,
wherein
the outlet openings are gill-shaped.

5. The apparatus according to claim 1,
wherein
the application device is arranged at least in sections above the first roller and the second roller and/or the application device is arranged in an end section of the rollers relative to the transport direction of the plastic preforms.

6. The apparatus according to claim 1,
wherein
the application device has a collection chamber for collecting the gaseous medium.

7. The apparatus according to claim 1,
wherein
the apparatus comprises a hold-down device arranged above the rollers, which is configured to prevent the plastic preforms from escaping from the gap.

8. The apparatus according to claim 1,
wherein
the apparatus comprises a guide blade for guiding the transported plastic preforms.

9. The apparatus according to claim 1,
wherein
the apparatus comprises an ejection device which is suitable and intended to eject incorrectly oriented plastic preforms.

10. A method for transporting plastic preforms, which have a main body and a mouth region, wherein a first roller rotating with respect to a first axis of rotation and a second roller rotating with respect to a second axis of rotation are provided, wherein the first axis of rotation and the second axis of rotation run parallel to each other and a gap is formed between the first roller and the second roller, which gap is dimensioned such that the main body passes through this gap and the mouth region does not pass through it, wherein the plastic preforms are transported along this gap and at least one application device applies a gaseous medium to the plastic preforms,
wherein
the application device is configured to apply the gaseous medium to the plastic preforms in their mouth region.
